(19) United States
(12) Patent Application Publication
(10) Pub. No.: US 2009/0100470 A1
(43) Pub. Date: Apr. 16, 2009

(54) INFORMATION PROCESSING DEVICE

(75) Inventors: Yuki Yai, Kawasaki (JP); Masashi Urushihara, Kawasaki (JP); Keigo Matsunaga, Kawasaki (JP); Yoshiro Munesada, Kawasaki (JP); Kanako Ariya, Kawasaki (JP); Hiroyuki Komai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/186,950

(22) Filed: Aug. 6, 2008

(30) Foreign Application Priority Data
Oct. 16, 2007 (JP) JP2007-269472
Mar. 19, 2008 (JP) JP2008-071972

(51) Int. Cl. H04N 5/445

(52) U.S. Cl. 725/46

(57) ABSTRACT

For enabling the user to acquire the desired information in a short period of time with a simple operation, an information processing device comprises: an extraction module that extracts at least one set of presenting information to be presented to a user from within a plurality of information groups; a control module that displays the plural pieces of presenting information extracted per information group by the extraction module on one display screen; and a display unit capable of displaying the display screen.

The disclosure of Japanese patent application No. 2008-071972 filed on Mar. 19, 2008 and Japanese patent application No. 2007-269472 filed on Oct. 16, 2007 including the specification, claims, drawings, and abstract is incorporated herein by reference in its entirety.

### BACKGROUND

1. Technical Field

The technical field relates to a technology of presenting information to a user.

2. Description of the Related Art

Over the recent years, it is a general practice to watch and listen to a TV program by use of a personal computer (PC) mounted with a TV tuner.

To be specific, the PC includes the TV tuner enabled to receive a TV broadcast, in which the TV program is received, then watched (reproduced) and recorded by executing a program [an AV (audio Visual) program) for watching and listening to the TV program.

Further, with respect to watching the TV programs using this type of PC a known function is a [Recommended Program] function of previously informing the user of broadcasting the TV program suited to a user's preference by analyzing the user's preference.

The [Recommended Program] function is, for example, a function of analyzing a tendency based on SI (Service Information) of the TV programs watched by the user in the past and the TV programs recorded by the user in the past, extracting based on a result of this analysis a TV program matching with the preference from the TV programs that will hereinafter be broadcasted, and introducing the extracted TV program as a recommended program to the user.

Specifically, as described above, a “Recommended Screen” organized by showing a list of information such as a schedule date of the broadcast, a name of a broadcasting station, a genre, and a content about one or more recommended programs determined to be matching with the user's preference and extracted, is displayed on a display.

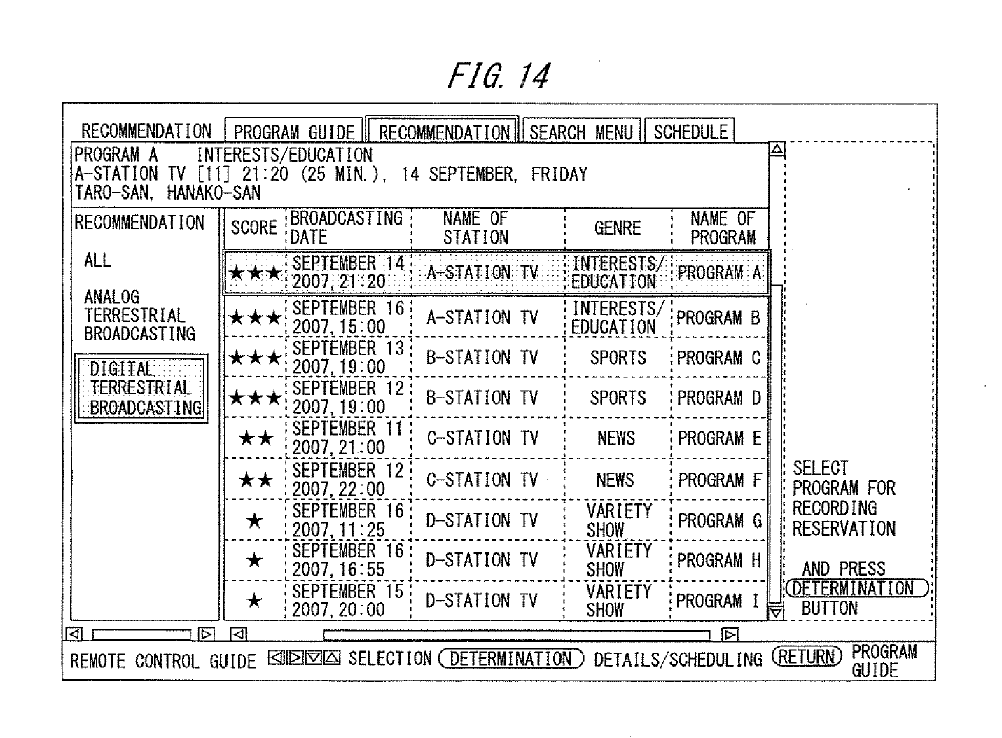

FIG. 14 is an explanatory diagram of a technique of presenting the recommended program in a conventional PC-based TV program watching system.

The conventional TV program watching system is configured to generate a dedicated screen (recommended screen) for showing a list of the recommended programs as illustrated in FIG. 14 and display this recommended screen on the display.

Then, the user refers to the program list displayed on the recommended screen, then, if there is a desire-to-watch program, selects this program by operating a mouse etc, and can schedule the selected program for watching and for recording.

Moreover, on the PC described above, a list of recording data (a library screen) of the recorded TV programs is displayed on the display, and the user searches for and selects the recording data of the desire-to-watch program based on the information such as the recording date/time, the title, etc, and regenerates the recording data thereof.

[Patent document 1]Japanese Patent Laid-Open Publication No. H11-007453

[Patent document 2]Japanese Patent Laid-Open Publication No. 2004-072502

### SUMMARY

There are, however, many cases in which the user is not necessarily clear about a purpose and a desire-to-watch object, then another possible case is that the user tentatively searches for something interesting after switching ON a power source of the PC, in this case the conventional TV program watching system, e.g., prompts the user to display, at first, the recommended screen on the display and to check the recommended programs, and, if there is no desire-to-watch program therein, the user next needs to perform an operation of displaying the library screen and searching for the recording data from within the displayed list, resulting in a problem that it is time-consuming for the user to reach the desire-to-watch TV program and the user needs to conduct the complicated operation.

In view of such a problem, it is an object to enable the user to acquire the desired information in a short period of time with a simple operation.

Therefore, an information processing device comprises: an extraction module that extracts at least one set of presenting information to be presented to a user from within a plurality of information groups; a control module that displays the plural pieces of presenting information extracted per information group by the extraction module on one display screen; and a display unit capable of displaying the display screen.

Further, an information presenting method for presenting information to a user, comprises: an extraction step of extracting at least one set of presenting information to be presented to a user from within a plurality of information groups; and a display step of displaying the plural pieces of presenting information extracted per information group in the extraction step on one display screen.

Still further, an information presenting program for making a computer execute an information presenting function of presenting information to a user, the program making the computer execute: an extraction step of extracting at least one set of presenting information to be presented to a user from within a plurality of information groups; and a display step of displaying the plural pieces of presenting information extracted per information group in the extraction step on one display screen.

Yet further, a readable-by-computer recording medium is recorded with the information presenting program described above.

According to the disclosed information processing device, the disclosed information presenting device, and the disclosed information presenting program, each set of presenting information is extracted from within the plurality of information groups and displayed on one display screen to be presented to the user, whereby the user can recognize the presenting information given from the plurality of information groups at one time with high usability, and a degree of satisfaction of the user can be improved.

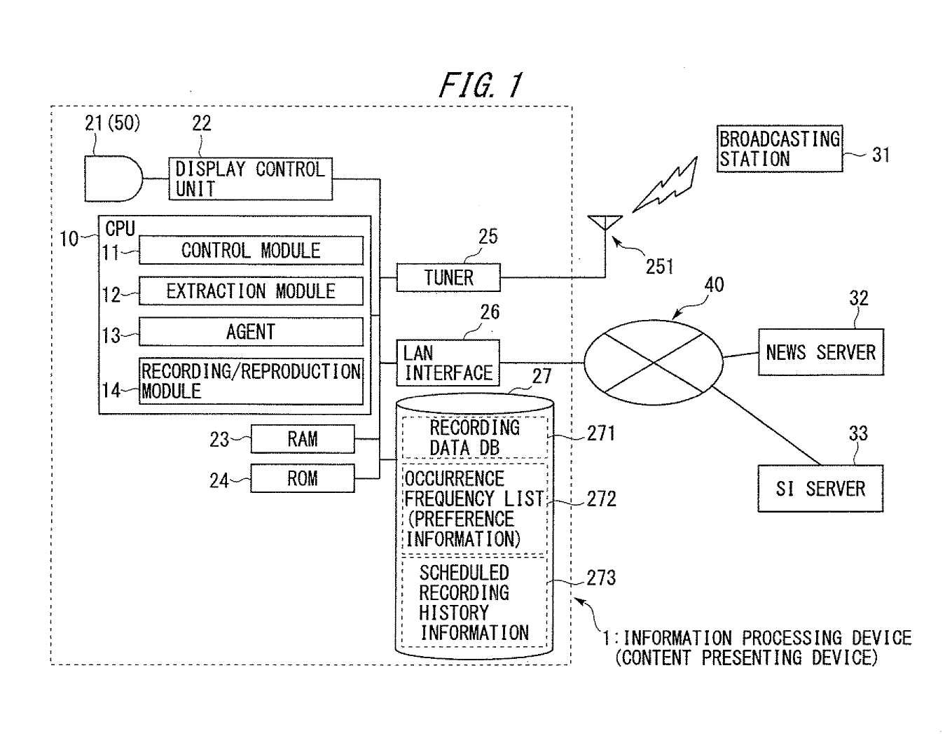

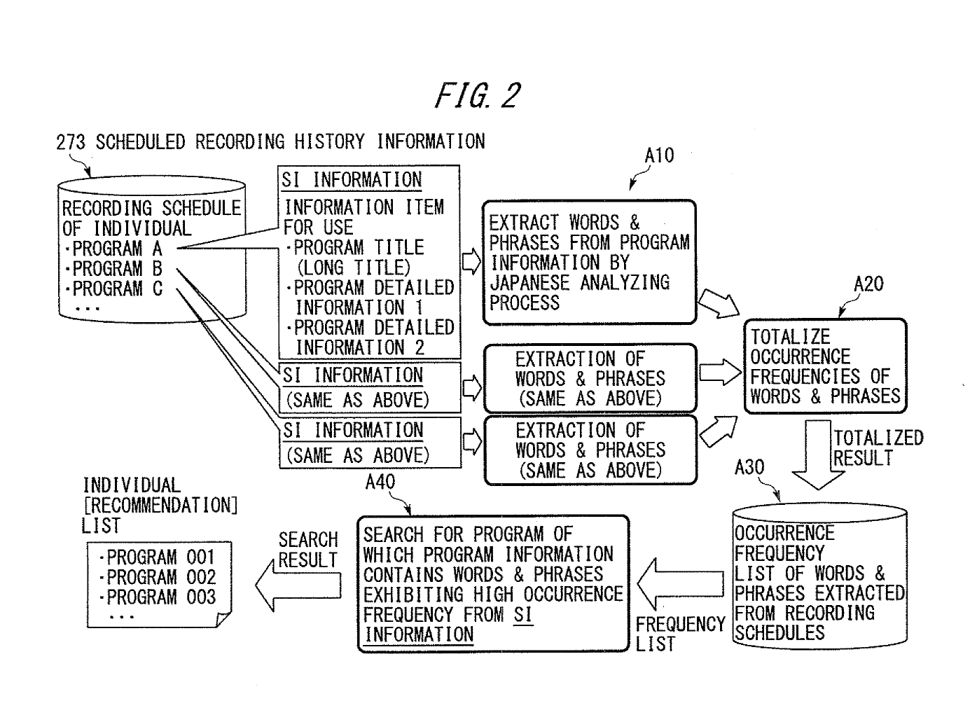

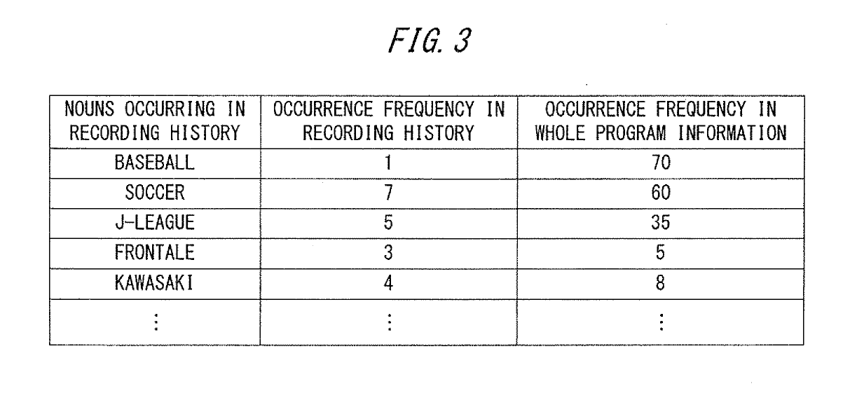

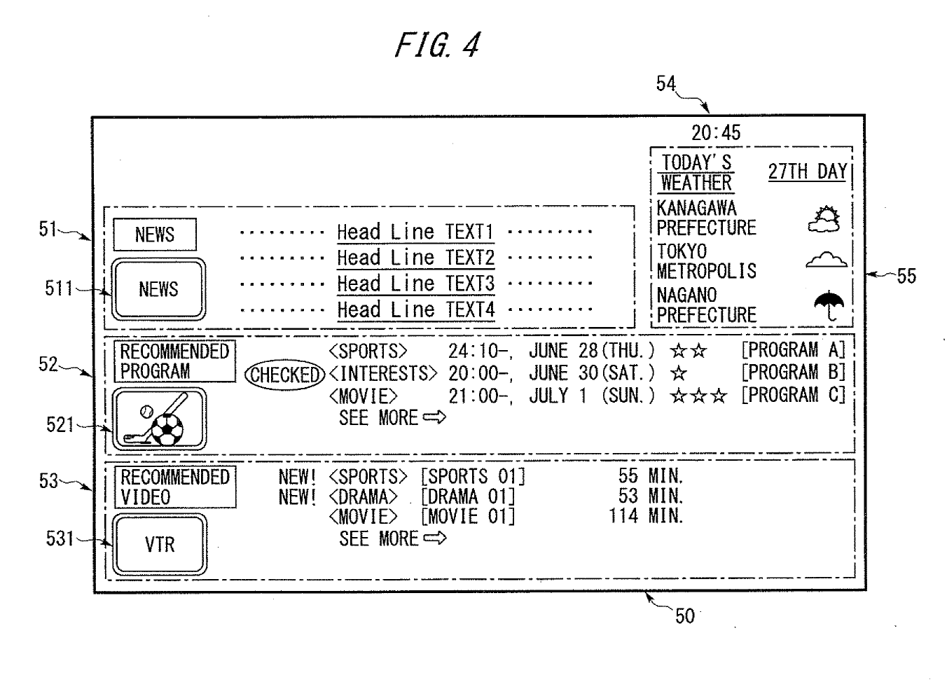

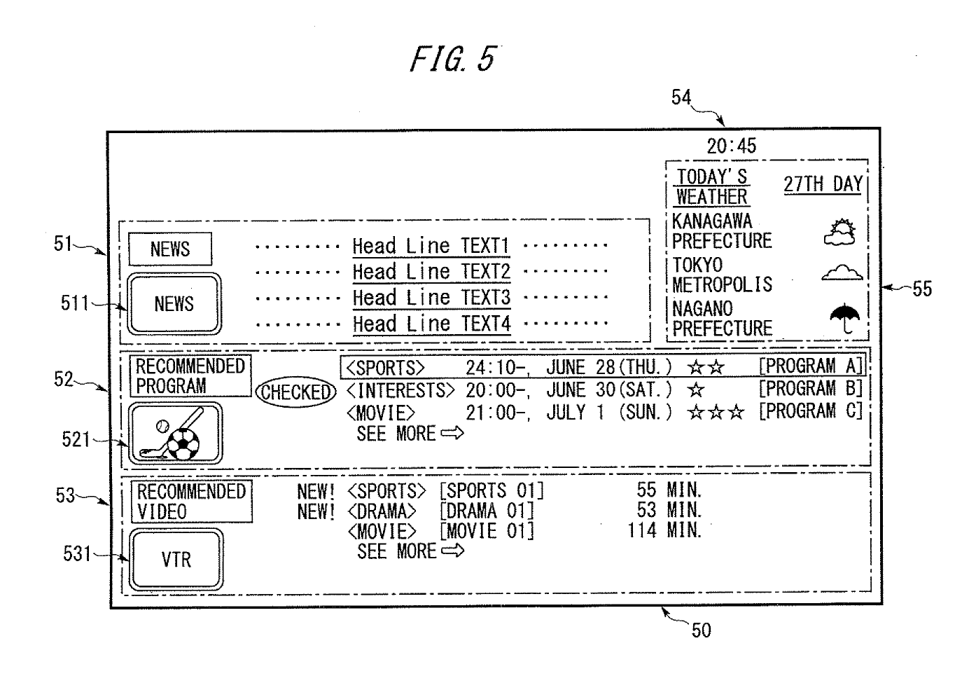

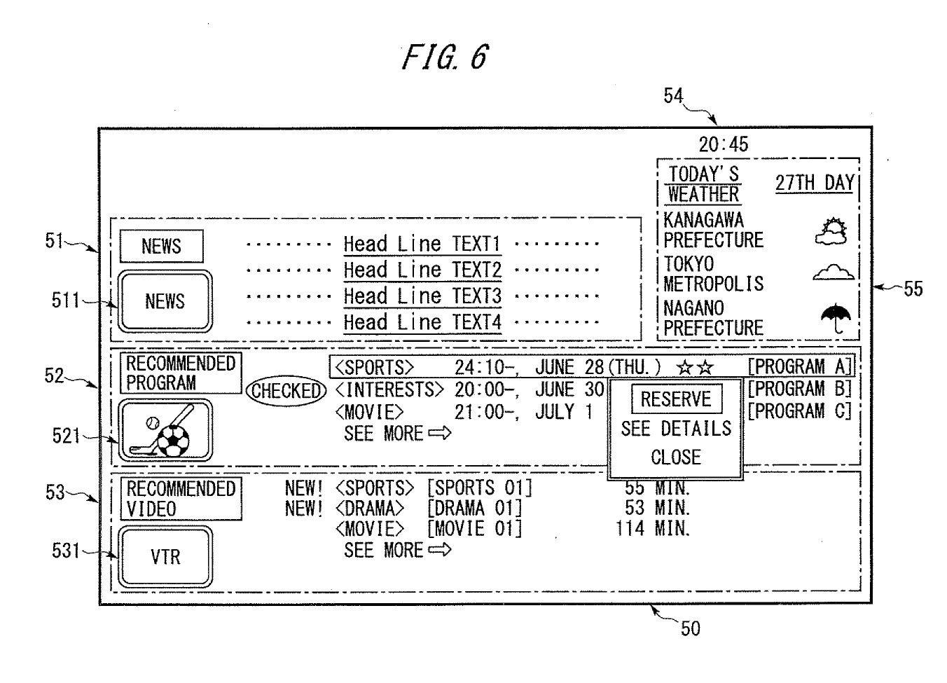

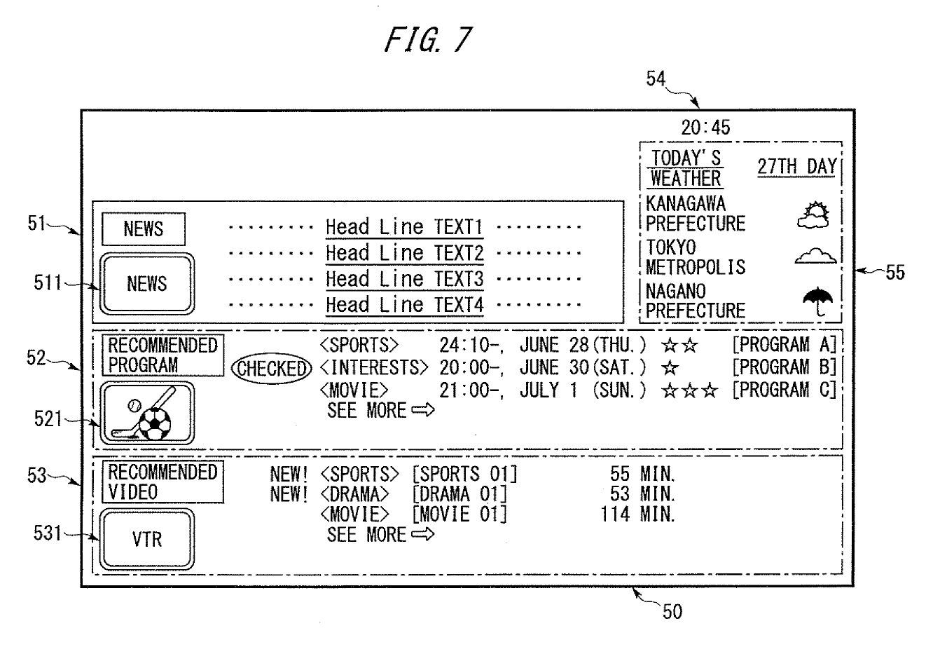

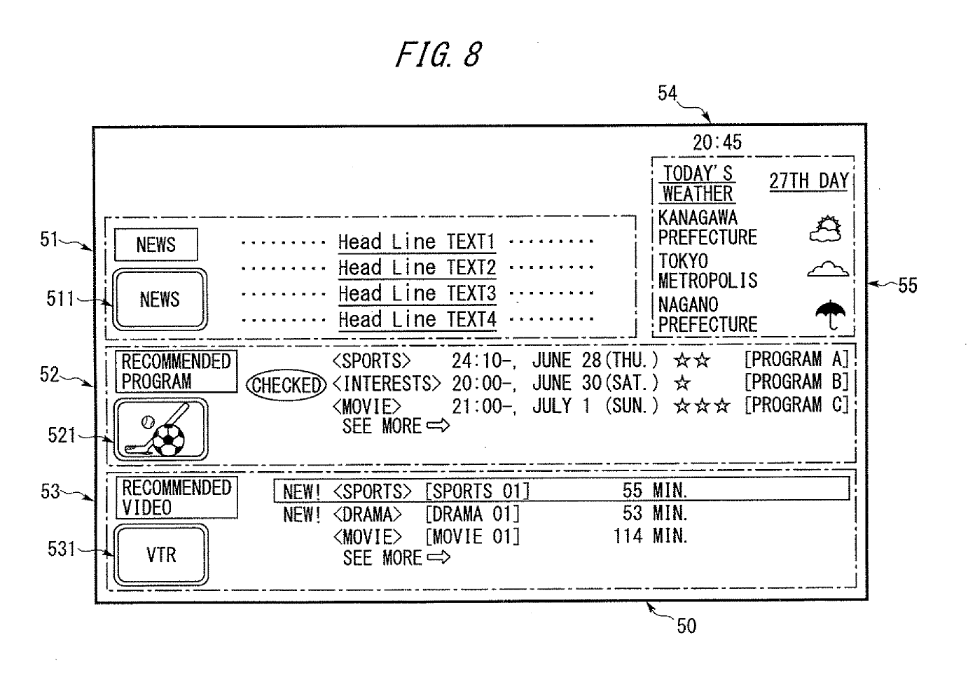

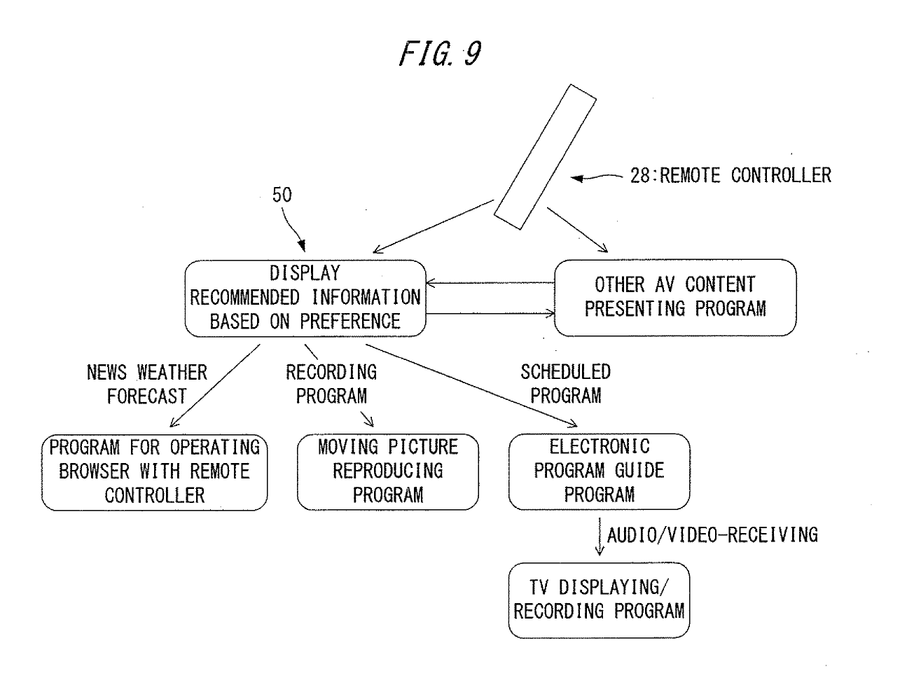

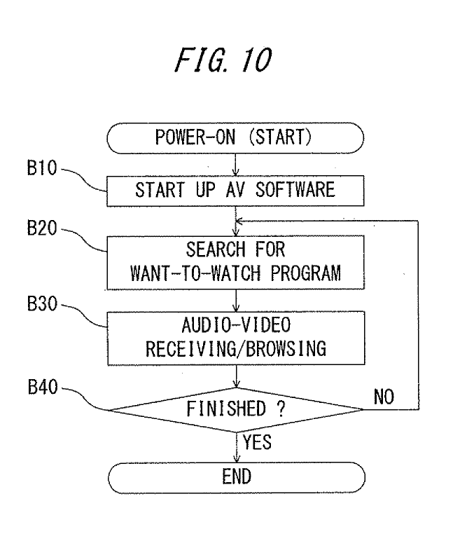

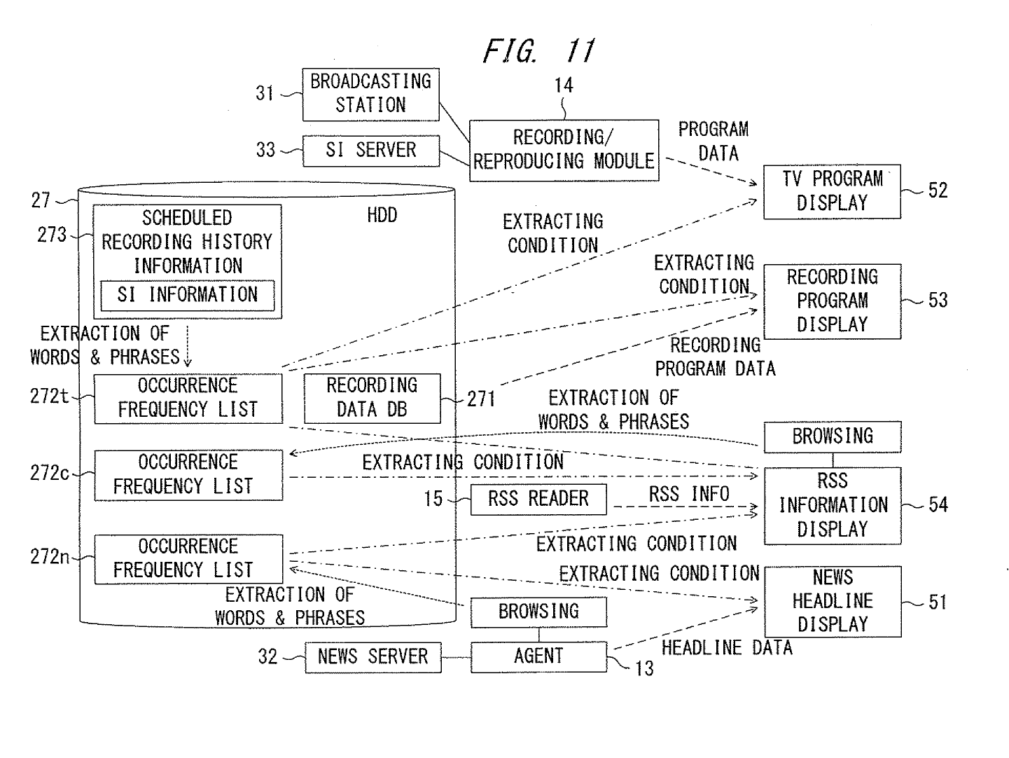

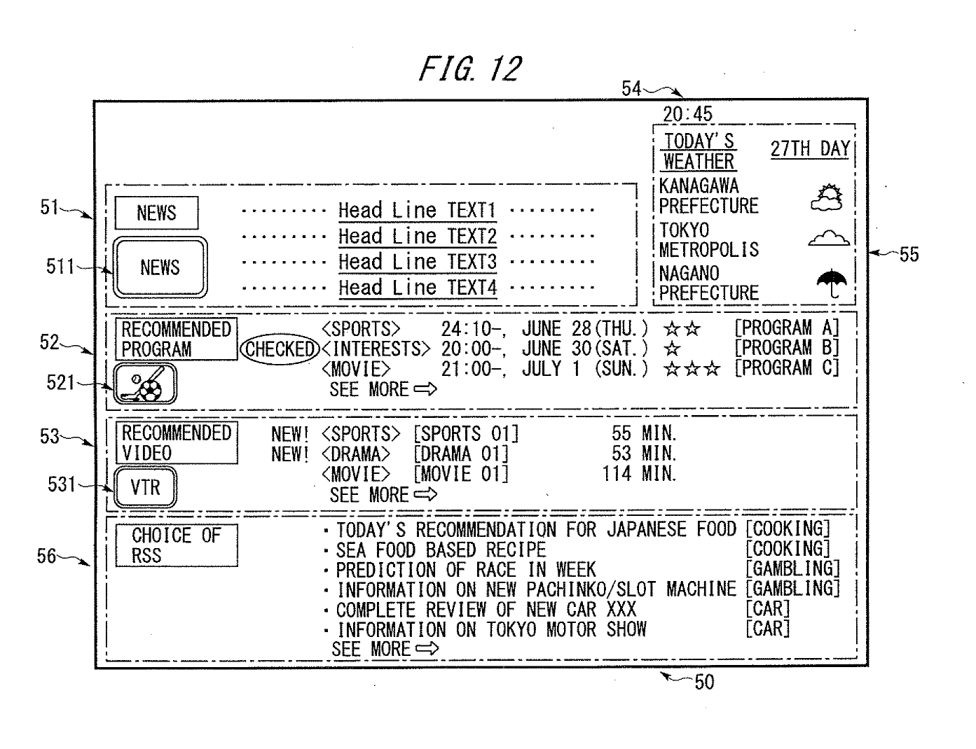

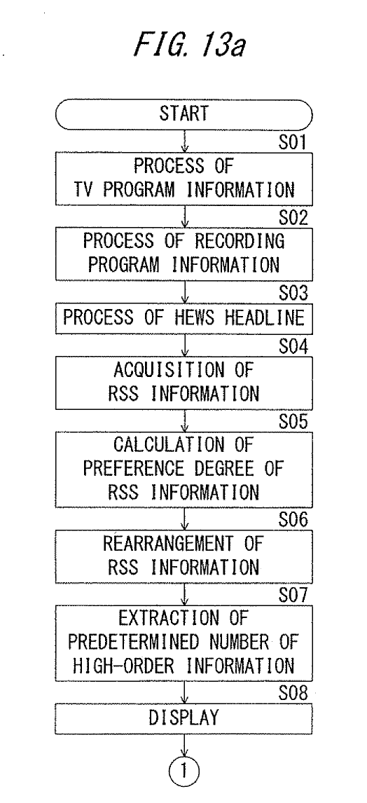

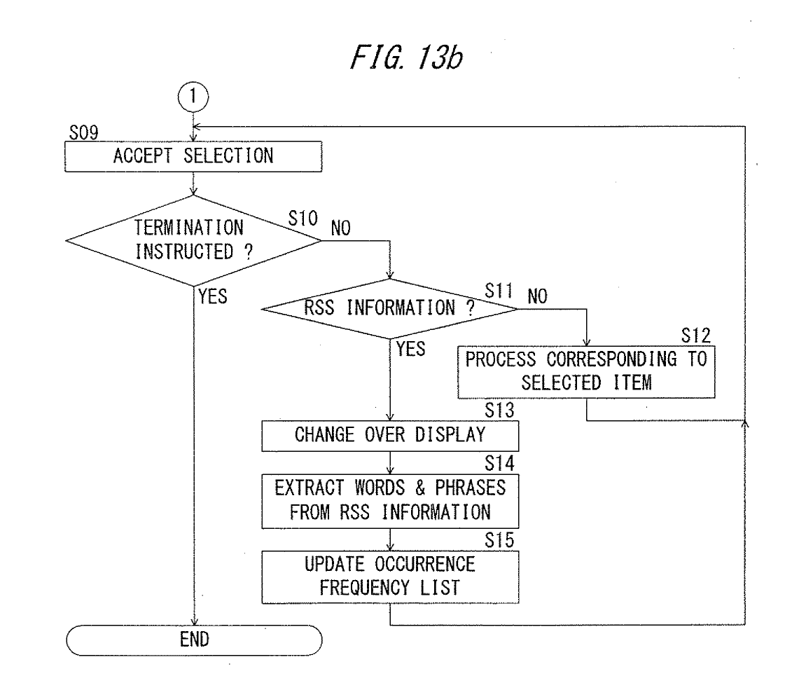

### BRIEF DESCRIPTION OF THE DRAWINGS

[FIG. 1] A diagram schematically showing a configuration of an information processing device by way of one embodiment.

[FIG. 2] An explanatory diagram showing an extraction method by which the extraction module extracts the presenting TV program in the information processing device by way of the embodiment.

[FIG. 3] An explanatory diagram showing an evaluation algorithm used when extracting a presenting TV program in the information processing device by way of the embodiment.

[FIG. 4] A diagram showing an example of the display screen for displaying the recommended information based on the preference in the information processing device by way of the embodiment.

[FIG. 5] A diagram showing an example of the display screen for displaying the recommended information based on the preference in the information processing device by way of the embodiment.

[FIG. 6] A diagram showing an example of the display screen for displaying the recommended information based on the preference in the information processing device by way of the embodiment.

[FIG. 7] A diagram showing an example of the display screen for displaying the recommended information based on the preference in the information processing device by way of the embodiment.

[FIG. 8] A diagram showing an example of the display screen for displaying the recommended information based on the preference in the information processing device by way of the embodiment.

[FIG. 9] A diagram schematically showing a software configuration in the information processing device by way of the embodiment.

[FIG. 10] An explanatory flowchart showing a method of utilizing the information processing device by way of the embodiment.

[FIG. 11] A diagram schematically showing a modified mode.

[FIG. 12] A diagram showing an example of the display screen in the modified mode.

[FIG. 13a] A flowchart showing a processing flow of the information presenting program (the AV software) in the modified mode.

[FIG. 13b] A flowchart showing a processing flow of the information presenting program (the AV software) in the modified mode.

[FIG. 14] An explanatory diagram of a technique of presenting the recommended program in a conventional PC-based TV program watching system.

### DETAILED DESCRIPTION OF THE PREFERRED EMBODIMENT

An embodiment will hereinafter be described with reference to the drawings.

FIG. 1 is a diagram schematically showing a configuration of an information processing device 1 by way of this embodiment.

The information processing device 1 is, as illustrated in FIG. 1, constructed as a computer system including a CPU (Central Processing Unit) 10, a display 21, a display control unit 22, a RAM (Random Access Memory) 23, a ROM (Read Only Memory) 24, a tuner 25, a LAN (Local Area Network) interface 26, and a HDD (Hard Disk Drive) 27.

Further, the information processing device 1 is connected in a communication-enabled status with a news server 32 and an SI server 33 via the Internet 40.

The news server 32 is a news distribution site provided by a newspaper publishing company etc, and distributes the news on the Internet 40. Further, the news server 32 supports RSS (RDF Site Summary, Rich Site Summary, Really Simple Syndication) and distributes information of the latest news based on the RSS.

The SI server 33 provides SI (Service Information) information such as EPG (Electronic Program Guide) on the Internet 40 and distributes, to be specific, program information on TV programs as the SI information. Herein, what is provided as the program information is detailed information such as the electronic program guide (EPG), titles (program titles) of the TV programs, names of performers (cast), and contents of the respective programs.

Moreover, the SI server 33 provides a variety of services such as a G guide, an ADAMS (Asahi Data And Multimedia Service)-EPG, and an Internet guide.

Note that the news server 32 and the SI server 33 are well known, and their in-depth descriptions are omitted.

Further, the information processing device 1 includes, as illustrated in FIG. 1, the tuner 25 and is enabled to receive TV broadcasting signals, and to reproduce and record the TV programs.

The tuner 25 receives and tunes in to the TV broadcasting signals of a variety of TV programs (a first information group) distributed from a broadcasting station 31 etc, and acquires audio/video signals. The tuner 25, to which an antenna 251 is connected as shown in FIG. 1, receives the TV broadcasting signals via the antenna 251.

Moreover, the tuner 25 receives, in addition to the TV broadcast described above, the SI (Service Information) such as the EPG (Electronic Program Guide) distributed together with the TV broadcasting signals by the broadcasting station 31.

The display 21 is a display device capable of displaying various categories of information based on display control by the display control unit 22 and, according to the embodiment, displays the various categories of information and messages presented to the users and, further, the TV programs, recording data, the news, etc.

The display control unit 22 performs display control of the display 21 and is realized by hardware such as a chipset including a display circuit and a video card and by software such as a display driver.

Furthermore, the display 21 displays a display screen 50 (see FIG. 4 etc) for displaying recommended information based on preferences that will be described later on, and functions as a display unit.

An HDD (a preference information storage unit) 27 is a storage device stored with various items of data, an OS (operating System), and a program, and is, in the information processing device 1, stored with an information presenting program, a recording data DB (Database) 271, an occurrence frequency list (preference information) 272, and a scheduled recording history information 273, which are used for the information processing device 1 to actualize an information presenting function.

The recording data DE 271 serves to manage, e.g., plural items of moving picture data (an information group, a second information group, or a content group), and manages the moving picture data (or information specifying a storage location; information, contents) and detailed information related to the moving picture data in a way that associates the moving picture data and the detailed information with each other.

Herein, the detailed information is information showing a content etc of the moving picture data. For instance, when the moving picture data is the recording data of the TV program, the detailed information involves using items of information such as a title and names of performers of the TV program and a content of the program, and these items of information are, as will be described later on, acquired as the SI (Service Information) information from the SI server 33 and from digital broadcasting waves that will hereinafter be explained. Note that the occurrence frequency list 272 and the scheduled recording history information 273 will be described later on.

The RAM 23 is, when the CPU 10 executes an arithmetic operation and the control, a storage device on which the data and the program are temporarily stored and developed. The ROM 24 is the storage device stored beforehand with the data and the program used for the CPU 10 to execute the arithmetic operation and the control.

The LAN interface 26 is an interface device that connects the information processing device 1 to the Internet 40 in the communication-enabled status, whereby the information processing device 1 is connected in the communication-enabled status to the news server 32 and the SI server 33 via the Internet 40.

The CPU 10 conducts the variety of arithmetic operations and the control, and executes the information presenting program, thereby functioning, in the information processing device 1, as a control module 11, an extraction module 12, an agent 13, and a recording/reproducing module 14.

Note that the program (information presenting program) for realizing the control module 11, the extraction module 12, the agent 13, and the recording/reproducing module 14, is provided in the form of being recorded on a readable-by-computer recording medium such as a flexible disc, a CD (CD-ROM, CD-R, CD-RW, etc), a DVD (DVD-ROM, DVD-RAM, DVD−R, DVD+R, DVD−RW, DVD+RW, HD DVD, etc), a Blu-ray Disc, a magnetic disc, an optical disc, and a magneto-optic disc. Then, the computer reads the program from the recording medium, transfers and stores the program to and in an internal storage device or an external storage device, and thus utilizes the program. Further, the program may be recorded on the storage device (recording medium) such as the magnetic disc, the optical disc, and the magneto-optic disc, and may thus be provided to the computer via a communication path from the storage device.

On the occasion of realizing the functions as the control module 11, the extraction module 12, the agent 13, and the recording/reproducing module 14, the program stored in the internal storage device (the RAM 23 and the ROM 24 in the embodiment) is executed by the microprocessor (the CPU 10 in the embodiment) of the computer. At this time, the computer may read and execute the program recorded on the recording medium.

Note that the computer in the embodiment is a concept embracing the hardware and the operating system (OS), and connotes the hardware operating under the control of the operating system. Further, if the operating system is not required and when the hardware is operated based on a sole application program, the hardware itself corresponds to the computer. The hardware includes at least the microprocessor such as the CPU and means for reading the computer program recorded on the recording medium, and in the embodiment the information processing device 1 has the function as the computer.

Still further, the recording medium in the embodiment can involve utilizing, in addition to the flexible disc, the CD, the DVD, the Blu-ray Disc, the magnetic disc, the optical disc, and the magneto-optic disc, a variety of readable-by-computer mediums such as an IC card, a ROM cartridge, a magnetic tape, a punch card, an internal storage device (a memory such as the RAM and the ROM), an external storage device, and printed matters printed with codes such as bar codes.

The recording/reproducing module 14 reproduces (displays) and records, e.g., the TV program received by the tuner 25, then regenerates the moving picture data stored in the HDD 27, and is realized by the CPU 10 executing a TV displaying/recording program and a moving picture reproducing program.

Moreover, the TV displaying/recording program, the moving picture reproducing program, and an EPG program can be executed in a variety of modifications within the scope that does not deviate from the gist of the embodiment.

For example, the information processing device 1 is preinstalled with an AV content presenting program enabling multiple mediums to be dealt with on the PC in addition to the TV displaying/recording program and the moving picture reproducing program, and can regenerate image data, music data, TV data, online data by use of other AV content presenting programs in place of the TV displaying/recording program and the moving picture reproducing program.

Moreover, the information processing device 1 is provided with a Browser capable of displaying the contents on the Internet 40 such as the Internet Explorer (registered trademark), and is further preinstalled with a program enabling operations such as a movement and determination with a mouse cursor and displaying a page in enlargement and reduction by use of a remote controller (RC) 28 (see FIG. 9) on the display screen of the Browser, whereby the contents on the Internet 40 can be smoothly manipulated by employing the RC 28.

Moreover, the recording/reproducing module 14, each time the user schedules the recording of the TV program, acquires the SI information about the program scheduled for recording and stores the SI information as scheduled recording history information 273 in the HDD 27 (see FIG. 2).

Incidentally, the SI information is distributed as carried on digital broadcasting waves from the broadcasting station 31, and the recording/reproducing module 14 can receive and acquire the SI information by use of the tuner 25. Moreover, the SI information contains the program information used for the EPG.

Further, the recording/reproducing module 14 can acquire the SI information via the LAN interface 26 from the SI server 33, and for example, when the TV broadcast is an analog broadcast, the SI information is acquired from the SI server 33.

The agent 13 accesses the news server (news distribution site) 32 etc via the Internet 40, then obtains the news from within a group of news (an information group, a content group; which might hereinafter be referred to as a news group) distributed by the news server 32, and includes a function as, e.g., an RSS (RDF Site Summary, Rich Site Summary, Really Simple Syndication) reader.

The extraction module 12 extracts at least one set of presenting information to be presented to the user from within a plurality of information groups, i.e., per information group, specifically, extracts a TV program (a recommended program, the presenting information, a presenting content; which will hereinafter be termed a presenting TV program) suited to a user's preference from within a plurality of TV programs (the information groups, the content groups; which will hereinafter be called TV program groups) provided by the broadcasting station 31 based on the SI information on the TV programs, and extracts the moving picture data (the presenting information, the presenting contents; which will hereinafter be referred to as presenting moving picture data) suited to the user's preference from within plural categories of moving picture data (the information groups, the content groups; which will hereinafter be called moving picture data groups) stored in the HDD 27 etc.

FIG. 2 is an explanatory diagram showing an extraction method by which the extraction module 12 extracts the presenting TV program in the information processing device 1 by way of the embodiment, and FIG. 3 is an explanatory diagram showing an evaluation algorithm used on the occasion of extracting the presenting TV program in the information processing device 1 by way of the embodiment.

The extraction module 12 extracts words & phrases in a language analyzing process (which is a Japanese analyzing process in the embodiment) from the SI information of each of the programs scheduled for recording based on the scheduled recording history information 273 generated by the recording/reproducing module 14 (step A10). Note that the extraction of the words & phrases can be actualized by employing a morphological analysis.

Then, the extraction module 12 totalizes occurrence frequencies of the extracted words & phrases (step A20), and generates the occurrence frequency list (a frequency list; the preference information) 272 of the extracted words & phrases from the recording schedule (step A30). Further, the thus-generated occurrence frequency list 272 is saved in the HDD 27 etc.

The extraction module 12 searches, from the SI information, for the TV program of which the words & phrases exhibiting the high occurrence frequency are contained in the program information in the occurrence frequency list 272 (step A40), and extracts, based on a result of this search, a plurality of presenting TV programs, thereby generating a presenting TV program list (a recommendation list).

Namely, the extraction module 12 extracts one or more presenting TV programs (presenting information) based on the occurrence frequency list (preference information) 272 stored in the HDD 27.

Moreover, the extraction module 12, when generating the recommendation list, assigns a higher priority order to the TV program containing more of nouns appearing in the program information included with the recording history, and determines, based on a decision criterion as to whether the noun is [characteristic] or not, the relative orders between the TV programs.

For instance, as illustrated in FIG. 3, the extraction module 12 calculates (counts) the occurrence frequencies in the recording history and the occurrence frequencies in the whole program information with respect to the individual nouns (which are [baseball], [soccer], [J-leauge], [Frontale], [Kawasaki] in the example shown in FIG. 3) acquired as a result of extracting the words & phrases by the extraction module 12 from the SI information of each of the programs scheduled for recording based on the scheduled recording history information 273.

Then, the extraction module 12 determines that the nouns (which are [baseball], [soccer] in the example illustrated in FIG. 3] exhibiting the high the occurrence frequencies in the entire program information are not so characteristic because of appearing a good number of TV programs, and, while on the other hand, determines that the nouns (which are [Frontale], [Kawasaki] in the example illustrated in FIG. 3] exhibiting the low the occurrence frequencies in the entire program information are characteristic nouns, thereby assigning the higher priority order to the TV program (the presenting TV program) of which the program information contains these characteristic nouns.

Note that at least a part (e.g., the program title, the genre, and the broadcasting date/time) of the program information on the presenting TV program extracted by the extraction module 12 is temporarily stored in a predetermined storage location of the HDD 27, the RAM 23, etc.

Further, the extraction module 12, when extracting the presenting moving picture data suited to the user's preference from within the plural categories of moving picture data (the moving picture data group) stored in the HDD 27 etc, in the same way as the extraction of the presenting TV program described above, extracts one or more presenting TV programs (the presenting information) based on the occurrence frequency list 272 and the SI information related to each category of moving picture data.

Note that at least a part (e.g., the title, the genre, the reproducing time) of the detailed information about the presenting moving picture data extracted by the extraction module 12 is temporarily stored in a predetermined storage location of the HDD 27, the RAM 23, etc.

Moreover, the extraction module 12 extracts the news suited to the user's preference from within plural items of news acquired from the news server 32 by the agent 13, then selectively extracts at least one or more items of news (the presenting information, the presenting news) of the genre (finance, sports, society, etc) designated by the user beforehand, and obtains at least a headline (a caption) of the news from the news server 32.

Note that the headline of the news extracted by the extraction module 12 is also temporarily stored in a predetermined storage location of the HDD 27, the RAM 23, etc.

The control module 11 displays, on one display screen (which will hereinafter be called the display screen for displaying the recommended information based on the preference) 50, the program information about one or more presenting TV programs extracted by the extraction module 12 from within the TV program group distributed from the broadcasting station 31, the detailed information about one or more items of presenting moving picture data extracted by the extraction module 12 from within the plural categories of moving picture data (the moving picture data group) stored in the HDD 27 etc, and the headlines of one or more items of presenting news extracted by the extraction module 12 from within the plural categories (genres) of news acquired from the news server 32 by the agent 13.

Namely, the control module 11 displays, on one display screen, the plural items of presenting information (the presenting TV program, the presenting moving picture data, the presenting news) extracted for each category of information (the TV program, the moving picture data, the news) by the extraction module 12.

FIGS. 4-8 are diagrams each showing an example of the display screen for displaying the recommended information based on the preference in the information processing device 1 by way of the embodiment.

The display screen 50 for displaying the recommended information based on the preference is a display screen displayed for the first time when executing the information presenting program (which might hereinafter be referred to as AV software) in the information processing device 1 and is built up in a way that includes, as shown in FIG. 4, a news headline area 51, a TV program information area 52, a moving picture data information area 53, a time display area 54, and a weather information area 55.

Herein, the news headline area 51 is an area for displaying headlines of one or more items of presenting news, and the control module 11 performs the display control so that the headlines of the news extracted by the extraction module 12 and temporarily stored in the predetermined storage location of the HDD 27, the RAM 23, etc are displayed in this news headline area 51.

Note that in the example illustrated in FIG. 4, the four presenting news headlines are displayed in lines in the news headline area 51, and an icon 511 representing the news is provided therein. Further, the icon 511 can be implemented in a variety of modifications of its design.

Moreover, the TV program information area 52 is an area for displaying the program information of one or more TV programs, and the control module 11 conducts the display control so that at least a part (e.g., the program title, the genre, and the broadcasting date/time) of the program information on the presenting TV programs extracted by the extraction module 12 and temporarily stored in the predetermined storage location of the HDD 27, the RAM 23, etc is displayed in the TV program information area 52.

Note that in the example shown in FIG. 4, the three presenting TV programs are displayed in lines in the TV program information area 52, and an icon 521 representing the TV program is provided therein.

Further, in the TV program information area 52, the TV program already scheduled for recording is marked with a piece of information (which is a mark formed by encircling a word [checked] in the example illustrated in FIG. 4) showing this purport.

Then, the icon 521 and the mark representing that the schedule for recording has already been done can be implemented in the variety of modifications of their designs.

Moreover, the moving picture data information area 53 is an area for displaying the detailed information about one or more categories of presenting moving picture data, and the control module 11 executes the display control so that at least a part (e.g., the title, the genre, the reproducing time) of the detailed information on the presenting moving picture data extracted by the extraction module 12 and temporarily stored in the predetermined storage location of the HDD 27, the RAM 23, etc is displayed in the moving picture data information area 53.

Incidentally, in the example shown in FIG. 4, the pieces of detailed information on the three categories of presenting moving picture data are displayed in lines in the moving picture data information area 53, and an icon 531 representing the moving picture data is provided therein.

Furthermore, a newly added category of moving picture data is attached with a piece of information (which is a word [New!] in the example illustrated in FIG. 4) in the moving picture data information area 53. Moreover, the icon 531 and the mark (word) representing the newly added moving picture data can be implemented in the variety of modifications of their designs.

The time display area 54 is an area for displaying the present time, and the control module 11 performs the display control so that the present time obtained, e.g., from a timer function incorporated into the information processing device 1 and the present time obtained by querying an NTP (Network Time Protocol) server/SNTP (Simple NTP) server and a TIME server via the LAN interface 26, are displayed in the time display area 54.

Further, the weather information area 55 is an area for displaying meteorological information (weather forecast), and the control module 11 conducts the display control so that a weather forecast extracted from a data broadcast that is contained in the digital broadcasting signals distributed from the broadcasting station 31 and weather forecast data acquired from the Internet 40 via the LAN interface 26, are displayed in the weather information area 55.

Note that the local weather forecast data of districts in which the information processing devices 1 are installed are displayed in the weather information area 55.

Namely, the display screen 50 for displaying the recommended information based on the preference is the display screen (for displaying the recommended information based on the preference) organized by arranging, on the same screen, the program information related to one or more presenting TV programs extracted by the extraction module 12 from within the TV program group distributed from the broadcasting station 31, the detailed information related to one or more categories of presenting moving picture data extracted by the extraction module 12 from within the plural categories of moving picture data (the moving picture data group) stored in the HDD 27 etc, and the headlines of one or more items of presenting news extracted by the extraction module 12 from within the plural items of news acquired from the news server 32 by the agent 13, and the control module 11 generates the display screen 50 for displaying the recommended information based on the preference and controls the display 21 to display the information.

Moreover, the selecting operation by the user on the display screen 50 for the recommended information based on the preference may be done from, e.g., a mouse and a keyboard (their illustrations are omitted) provided as input devices of the information processing device 1 and may also involve using the RC (remote controller) 28, wherein this scheme can be implemented in the variety of modifications in the range that does not deviate from the gist of the embodiment.

Incidentally, if operated on the Browser by use of the RC 28, this operation is carried out in combination with a program for operating the Browser with the remote controller 28 described above.

Then, on the display screen 50 for displaying the recommended information based on the preference shown in FIG. 4, when the user desires to watch, e.g., the TV program and selects one of the TV programs (the recommended programs) in the TV program information area 52, as illustrated in FIG. 5, a display status is changed in such a way that the selected TV program is framed, and thereafter, as shown in FIG. 6, processes operable for the selected TV program (the recommended program) selected in FIG. 5 are displayed as operation candidates in a hop-up window format.

Note that the same numerals and symbols as those described above throughout the drawings represent the same or substantially the similar portions, and hence their explanations are omitted.

In the example shown in FIG. 6, two types of operations such as [Schedule] and [See details] can be done with respect to the selected TV program, and, if the user selects [Schedule], for example, the recording/reproducing module 14 schedules the recording of this TV program. On the other hand, if the user selects [See details], the program information on this TV program is displayed.

Moreover, if neither, [Schedule] nor [See details] is selected, the operation can revert to the status shown in FIG. 5 by selecting [Close].

Further, on the display screen 50 for displaying the recommended information based on the preference shown in FIG. 4, when the user desires to watch, e.g., the news and selects the news headline area 51, as illustrated in FIG. 7, a display status is changed such as framing the whole news headline area 51 and changing a background color in the news headline area 51.

Then, thereafter, for instance, the Browser is started up and, a list of the headlines (the illustrations are omitted) of the news acquired from the news server 32 by the agent 13 is displayed on the Browser, then the user selects an arbitrary item of desire-to-watch news from within the news headlines, and the selected news is displayed on the Browser.

Further, on the display screen 50 for displaying the recommended information based on the preference illustrated in FIG. 4, when the user desires to watch and listen to the moving picture data and selects one category of moving picture data in the moving picture data information area 53, as shown in FIG. 8, the display status is changed in a way that frames the selected moving picture data in the moving picture data information area 53, and the moving picture data starts being regenerated.

FIG. 9 is a diagram schematically showing a software configuration in the information processing device 1 by way of the embodiment.

As illustrated in FIG. 9, the information processing device 1 is, as discussed above, preinstalled with the Browser, the program for operating the Browser with the remote controller 28, the moving picture reproducing program, the EPG program, the TV displaying/recording program, and other AV content presenting programs, and each of these programs is associated with any one of the news headline area 51, the TV program information area 52, the moving picture data information area 53, the time display area 54, and the weather information area 55 on the display screen 50 for displaying the recommended information based on the preference.

On the display screen 50 for displaying the recommended information based on the preference, when the user selects, e.g., the news displayed in the news headline area 51 or the weather forecast displayed in the weather information area 55 by operating the RC 28, the Browser is started up, and the news or the weather forecast are displayed on the Browser. Further, on this occasion, the program enabling the contents on the Internet to be handled by operating the RC 28 is started up, and the selecting operation etc can be done on the Browser by use of the RC 28.

Moreover, when the user selects the moving picture data displayed in the moving picture data information area 53, for instance, the moving picture reproducing program is started up, and the selected moving picture data starts being regenerated by the moving picture reproducing program.

On the other hand, when the user schedules the reproduction (playback) or the recording of the TV program displayed in the TV program information area 52, for example, the EPG program is started up to enable the scheduling to be done, or the TV displaying/recording program is started up to enable the user to watch and listen to the TV program.

Moreover, the user can start up, in place of the display screen 50 for displaying the recommended information based on the preference, other AV content presenting programs and can reproduce the variety of contents by starting up these programs according to the desire.

A method of using the thus-configured information processing device 1 will be explained by way of the embodiment with reference to a flowchart (step B10-step B40) shown in FIG. 10.

The user switches ON the power source (power-ON), and starts up the AV software just wondering if there is something interesting (step B10). The AV software is started up, whereby the display screen 50 for displaying the recommended information based on the preference is displayed on the display 21. On the display screen 50 for displaying the recommended information based on the preference, various genres of information (the TV programs, the moving picture data, the news) are presented at one time, and the user can look through the various genres of information without performing the complicated screen switching operation (step B20).

Then, the user, if there is the desire-to-watch information in the various genres of information (the TV program, the moving picture data, the news) displayed on the display screen 50 for displaying the recommended information based on the preference, selects and gets this information displayed.

Further, on the display screen 50 for displaying the recommended information based on the preference, if there is not any desire-to-watch information or if the user has already watched all genres of information, the user searches for other recommended genres of information by use of a search function of the information processing device 1 (step B20), and watches/browses a result of this search (step B30)

The user judges whether the user finishes watching/browsing the information or not (step B40), and, the processing returns to step B20 if not (refer to a NO-route in step B40) but comes to an end whereas if finished (refer to a YES-route in step B40).

Thus, according to the information processing device 1 exemplified by way of the embodiment, on the display screen 50 for displaying the recommended information based on one preference, the various genres (the categories, the information group) of information (e.g., the TV program, the moving picture data, the news) are displayed and presented to the user, whereby the user can recognize these plural genres of presenting information (e.g., the presenting TV program, the presenting moving picture data, the presenting news) at one time with high usability, which improves a degree of satisfaction of the user.

Further, the extraction module 12 extracts the presenting information based on the occurrence frequency list 272 generated by extracting (the words & phrases) from the recording schedules, thereby enabling the user's preference to be surely reflected in and the usability to be increased by eliminating the necessity for the user to take the trouble to register the preference information.

Moreover, the extraction module 12 assigns the higher priority order to the TV program containing more of the nouns appearing in the program information included with the recording history on the occasion of generating the recommendation list, and the user's preference can be certainly reflected in by determining, based on the decision criterion as to whether the noun is [characteristic] or not, the relative orders between the TV programs.

It should be noted that this scheme can be carried out in the variety of modifications in the scope that deviates from the gist of the embodiment irrespective of the embodiment discussed above.

Take the display screen 50 for displaying the recommended information based on the preference shown in FIG. 5 for example, in the embodiment discussed above, the four presenting news headlines are displayed in the news headline area 51, the three presenting TV programs are displayed in the TV program information area 52, and the three presenting moving picture data are displayed in the moving picture data information area 53, respectively, however, without being limited to this scheme, the display elements of which the number is other than the counts given above may be displayed in a way that changes a character size etc, and the scheme can be carried out in the variety of modifications in the scope that deviates from the gist of the embodiment.

Then, when displaying the presenting news headlines in the news headline area 51, the presenting TV programs in the TV program information area 52, and the presenting moving picture data in the moving picture data information area 53 respectively, if unable to display all of the display-target presenting TV programs, presenting TV programs and presenting moving picture data in the news headline area 51, the TV program information area 52, and the moving picture data information area 53 at one time due to a large number of these display elements, the user may manipulate a scroll bar and a scroll button disposed within the display screen 50 for displaying the recommended information based on the preference, thus scrolling down the overflow presenting news headlines, presenting TV programs, and presenting moving picture data off these areas.

Moreover, in the embodiment discussed above, the display screen 50 for displaying the recommended information based on the preference is configured by including the news headline area 51, the TV program information area 52, the moving picture data information area 53, the time display area 54, and the weather information area 55, however, without being limited to this configuration, in addition to the news, the TV programs, the moving picture data, the time and the weather forecasts described above, other categories of information may be displayed, and any one category of information among these categories of information may not be displayed.

For example, the dynamic images (the network moving pictures) distributed from a moving picture distribution server on the Internet 40 may also be presented on the display screen 50 for displaying the recommended information based on the preference.

The moving picture distribution server distributes the moving picture data on the Internet 40, wherein the user can download the moving picture data via the Internet 40, and can regenerate and store the data in a storage medium such as the HDD 27.

Then, in the information processing device 1, when presenting the network moving picture acquired from the moving picture distribution server, the extraction module 12 may, in the same way as in the case of the presenting TV program and the presenting moving picture data, search the occurrence frequency list 272 described above for the attached information (SI information) attached to the network moving picture, thus may extract one or more network moving pictures (the presenting network moving pictures) suited to the user's presence and may further, on this occasion, assign the priority order based on the characteristic noun, and this scheme can be carried out in the variety of modifications in the scope that deviates from the gist of the embodiment.

Moreover, the embodiment discussed above has exemplified the example of presenting the recommended information to the user in the information processing device 1, however, without being limited to this scheme, the recommended information may be presented in other types of devices such as a PVR (Personal Video Recorder which is a recording device mounted with a HDD, a DVD, etc; an information presenting device), and the scheme can be carried out in the variety of modifications in the scope that deviates from the gist of the embodiment.

Moreover, the method of extracting the presenting TV program etc by the extraction module 12 is not limited to the embodiment discussed above, and the extraction method can be realized by employing a variety of well-known techniques.

It is to be noted that the embodiment can be embodied and manufactured on the premise so that the embodiment is disclosed.

### Modified Mode

FIG. 11 is a diagram schematically showing a modified mode.

S In the information processing device 1 according to the modified mode, the HDD (the preference information storage unit) 27 is stored with the information presenting program (11-14) for actualizing the information presenting function, the recording data DB 271, the occurrence frequency lists (the preference information) 272t, 272n, and the scheduled recording history information 273.

Then, in the same way as in the embodiment discussed above, the modified mode is that the extraction module 12 executes the processes of extracting the words & phrases by the language analyzing process (which is the Japanese analyzing process in the modified mode) from the SI information of each program scheduled for recording based on the scheduled recording history information 273 generated by the recording/reproducing module 14, and generating the occurrence frequency list (the preference information) 272tfor the program.

The extraction module 12 searches for the program information distributed from the broadcasting station 31 or the SI server 33 in a way that uses, as the search condition, the words & phrases exhibiting the high occurrence frequency in the occurrence frequency list (the preference information) 272tfor the program. The program information detected by the extraction module 12 is displayed as the program information related to the presenting TV program by the control module 11 in the TV program information area 52 on the display screen 50.

Further, in the same way as in the embodiment discussed above, in the modified mode also, the extraction module 12 searches for the detailed information related to the plural categories of moving picture data in the recording data DB 271 in a way that employs, as the search condition, the words & phrases exhibiting the high occurrence frequency in the occurrence frequency list (the preference information) for the program.

The detailed information extracted by the extraction module 12 is displayed as the detailed information related to the presenting moving picture data by the control module 11 in the moving picture data information area 53 on the display screen 50.

Moreover, in the same way as in the embodiment discussed above, in the modified mode also, the extraction module 12 executes the processes of extracting the words & phrases by the Japanese analyzing process based on the news browsed by the user in the plural items of news acquired from the news server 32 by the agent 13, and generating the occurrence frequency list (the preference information) for the news.

The extraction module 12 searches for the news headlines acquired by the agent 13 in a way that uses, as the search condition, the words & phrases exhibiting the high occurrence frequency in the occurrence frequency list (the preference information) 272nfor the news. The news headlines detected by the extraction module 12 are displayed as the news headlines related to the presenting news by the control module 11 in the news headline area 51 on the display screen 50.

Furthermore, the information processing device 1 in the modified mode includes an RSS reader 15 in the HDD 27 as a function that is not provided in the embodiment discussed above. The RSS reader 15 is defined as a program for acquiring the RSS information via the Internet 40.

The extraction module 12 in the modified mode searches for the RSS information to be displayed on the display screen 50 from within the RSS information acquired by the RSS reader 15 based on the occurrence frequency list (the preference information) 272tfor the program and the occurrence frequency list (the preference information) 272nfor the news. Then, the control module 11 in the modified mode displays, as the presenting information, the RSS information detected by the extraction module 12 in an RSS information display area 56 on the display screen 50.

FIG. 12 is a diagram showing an example of the display screen 50 in the modified mode.

The display screen 50 in the modified mode also includes the news headline area 51, the TV program information area 52, and the moving picture data information area 53, and further an addition of the RSS information display area 56. The RSS information extracted by the extraction module 12 from within the RSS information acquired by the RSS reader 15 is displayed as a list in the RSS information display area 56.

The RSS information displayed in the RSS information display area 56 is selected by the user, at which time the extraction module 12 executes the process of extracting, based on the selected RSS information, the words & phrases by the Japanese analyzing process, and generating the occurrence frequency list (the preference information) 272c for favorites.

Note that the extraction module 12 in the modified mode, in the case of searching for the RSS information to be displayed on the display screen 50 from within the RSS information obtained by the RSS reader 15, utilizes the occurrence frequency list (the preference information) 272tfor the program and the occurrence frequency list (the preference information) 272nfor the news when there is a small quantity of accumulation of the occurrence frequencies in the occurrence frequency list (the preference information) 272c for the favorites, and utilizes the three occurrence frequency lists (the preference information) 272t, 272n, 272c when there is a large quantity of accumulation of the occurrence frequencies in the occurrence frequency list (the preference information) 272c for the favorites.

FIGS. 13a and 13b are flowcharts each showing a processing flow of the information presenting program (the AV software) in the modified mode.

The information processing device 1, when given a startup instruction from the user, starts up the information presenting program (11-15). Then, the extraction module 12, as described above, executes the process of searching for the program information distributed from the broadcasting station 31 or the SI server 33 in a way that uses, as the search condition, the words & phrases exhibiting the high occurrence frequency in the occurrence frequency list (the preference information) 272tfor the program (S01), subsequently, as described above, executes the process of searching for the detailed information related to the plural categories of moving picture data in the recording data DB 271 in a way that employs, as the search condition, the words & phrases exhibiting the high occurrence frequency in the occurrence frequency list (the preference information) for the program (S02), and further executes the process of searching for the news headlines acquired by the agent 13 in a way that uses, as the search condition, the words & phrases exhibiting the high occurrence frequency in the occurrence frequency list (the preference information) 272nfor the news (S03).

Subsequently, the extraction module 12 acquires the RSS information from the RSS reader 15 (S04), and calculates a degree of preference of each piece of RSS information. The degree of preference is a degree of how much the words & phrases showing the high occurrence frequency are contained in the three occurrence frequency lists (the preference information) 272t, 272n, 272c and gets higher as more of the words & phrases exhibiting the high occurrence frequency are contained therein. When calculating the degree of preference with respect to all pieces of RSS information, the extraction module 12 rearranges the RSS information in the order from the highest degree of preference (S05), and extracts a predetermined number of higher-order RSS information (S06).

Thereafter, the control module 11 performs the control of displaying the display screen 50 on the display 21. On the display screen 50, the program information, the detailed information, and the news headlines detected by the extraction module 12 are contained in the news headline area 51, the TV program information area 52, and the moving picture data information area 53, and the RSS information extracted by the extraction module 12 is contained in the RSS information area 56. Furthermore, the pieces of RSS information are arranged in the sequence from the highest degree of preference in the RSS information display area 56.

The control module 11 stands by till the user selects one of some options in the display screen 50 and, upon accepting the selection thereof (S09), determines whether the accepted selection item is an end instruction or not (S10). If the selection item is not the end instruction, the control module 11 determines whether the RSS information in the RSS information display area 56 is selected or not (S11), and, after executing the process corresponding to the selected item if the RSS information is not selected (S12), returns to a status for accepting the selection (S09). On the other hand, when the RSS information is selected, the control module 11 executes a process of changing a page displayed in the display 21 into a page based on the selected RSS information (S13).

Thereafter, the control module 11 extracts the words & phrases by the Japanese analyzing process from the selected RSS information (S14), then executes a process of updating the occurrence frequency list (the preference information) 272c for the favorites (S15), and returns to the status for accepting the selection (S09).

While on the other hand, if the selected item accepted from the user is the end instruction, the control module 11 terminates the process based on the information presenting program (the AV software).

In this manner, according to the information processing device 1 by way of the modified mode, the various genres (the categories, the information group) of information (e.g., the TV program, the moving picture data, the news, the RSS information) are displayed on the display screen 50 for displaying the recommended information based on one preference, and thus presented to the user, thereby enabling the user to recognize the plural genres of presenting information (e.g., the presenting TV program, the presenting moving picture data, the presenting news, the presenting RSS information) at one time with the high usability, and enabling the degree of satisfaction of the user to be improved.

Besides, according to the modified mode, the RSS information acquired by the RSS reader 15 is selected based on at least the occurrence frequency list (the preference information) 272tfor the program and the occurrence frequency list (the preference information) 272nfor the news, and is thereafter displayed in the RSS information display area 56 on the display screen 50. Hence, only the information having the high preference of the user can be presented.

Besides, the pieces of RSS information are arranged in the sequence from the highest degree of preference in the RSS information display area 56 and displayed in the upper lines with the higher degree of preference, and consequently the information exhibiting the high preference of the user is not displayed in a position that needs scrolling.

Note that in the modified mode, the sequence of arranging the respective areas 51-53 on the display screen 50 is fixed, however, the arrangement sequence of the areas 51-53 and 56 may be set variable. For example, the control module 11 calculates, with respect to the areas 51-53 and 56, the degrees of preferences of the respective categories of information (the program information, the moving picture data information, the news, the RSS information) in these areas, then calculates average values of these degrees of preferences, and may arrange the areas 51-53 and 56 in the sequence from the highest average value of the degrees of the preferences. Moreover, the areas 51-53 and 56 may also be arranged in the sequence not from the highest average value of the degrees of the preferences but from the largest selection count of the information in the areas 51-53 and 56.

Moreover, in the modified mode, the size of each of the areas 51-53 and 56 on the display screen 50 is fixed but may also be set variable. For instance, the control module 11, with respect to the areas 51-53 and 56, calculates the average values of the degrees of the preferences of the respective categories of information (the program information, the moving picture data information, the news, the RSS information) in these areas, and may set larger the sizes of the areas 51-53 and 56 in the sequence from the highest average value of the degrees of the preferences. Furthermore, the areas 51-53 and 56 may also be set larger in the sequence not from the highest average value of the degrees of the preferences but from the largest selection count of the information in the areas 51-53 and 56.

It is feasible to apply to the use for presenting the various categories of information other than the TV program, the moving picture data and the network moving picture to the user.

What is claimed is:

1. An information processing device comprising:
an extraction module that extracts at least one set of presenting information to be presented to a user from within a plurality of information groups;
a control module that displays the plural pieces of presenting information extracted per information group by the extraction module on one display screen; and
a display unit capable of displaying the display screen.

2. An information processing device according to claim 1, further comprising:
a preference information storage unit capable of storing preference information showing a user's preference,
wherein the extraction module extracts, based on the preference information stored in the preference information storage unit, the presenting information.

3. An information processing device according to claim 1, further comprising:
a TV tuner capable of receiving a TV broadcast,
wherein the plurality of information groups includes TV programs.

4. An information processing device according to claim 1,
wherein the information group contains moving picture data.

5. An information processing device according to claim 1,
wherein the preference information storage unit capable of storing the preference information showing the user's preference is provided for every plurality of information groups.

6. An information processing device according to claim 1,
wherein the control module displays the pieces of presenting information extracted by the extraction module on the display screen in a way that rearranges the presenting information.

7. An information processing device according to claim 1,
wherein the preference information storage unit capable of storing the preference information showing the user's preference is provided for every plurality of information groups, and
the extraction module extracts, based on two or more pieces of preference information stored in the preference information storage unit, the presenting information from within any one information group.

8. An information presenting device presenting information to a user, comprising:
an extraction module that extracts at least one set of presenting information to be presented to a user from within a plurality of information groups; and
a control module that displays the plural pieces of presenting information extracted per information group by the extraction module on one display screen.

9. An information presenting device according to claim 8, further comprising:
a preference information storage unit capable of storing preference information showing a user's preference,
wherein the extraction module extracts, based on the preference information stored in the preference information storage unit, the presenting information.

10. An information presenting device according to claim 8,
wherein the plurality of information groups includes TV programs.

11. An information presenting device according to claim 8,
wherein the information group contains moving picture data.

12. An information presenting method of presenting information to a user, comprising steps of:
extracting at least one set of presenting information to be presented to a user from within a plurality of information groups; and
displaying the plural pieces of presenting information extracted per information group in the extraction step on one display screen.

13. An information presenting method according to claim 12,
wherein the extraction step includes extracting the presenting information based on the preference information showing a user's preference that is stored beforehand in a preference information storage unit.

14. An information presenting method according to claim 12,
wherein the plurality of information groups includes TV programs.

15. An information presenting method according to claim 12,
wherein the information group contains moving picture data.

16. A readable-by-computer recording medium recorded with an information presenting program for making a computer execute an information presenting function of presenting information to a user, the program making the computer execute steps of:
extracting at least one set of presenting information to be presented to a user from within a plurality of information groups; and
displaying the plural pieces of presenting information extracted per information group in the extraction step on one display screen.

17. A readable-by-computer recording medium recorded with an information presenting program according to claim 16,
wherein the extraction step includes making the computer execute so as to extract the presenting information based on the preference information showing a user's preference that is stored beforehand in a preference information storage unit.

18. A readable-by-computer recording medium recorded with an information presenting program according to claim 16,
wherein the plurality of information groups includes TV programs.

19. A readable-by-computer recording medium recorded with an information presenting program according to claim 16,
wherein the information group contains moving picture data.
